(19) United States
(12) Patent Application Publication
(10) Pub. No.: US 2023/0398481 A1
(43) Pub. Date: Dec. 14, 2023

(54) AIR FILTER MOUNTING SYSTEM

(71) Applicant: Permatron Corporation, Elk Grove Village, IL (US)

(72) Inventors: Brett Wall, St. Charles, IL (US); Jim Moran, Elk Grove Village, IL (US); Gabriel Hernandez, Elk Grove Village, IL (US); Anthony Dimicelli, Houston, TX (US); Mark Williams, Houston, TX (US)

(21) Appl. No.: 18/207,218

(22) Filed: Jun. 8, 2023

Related U.S. Application Data
(60) Provisional application No. 63/350,069, filed on Jun. 8, 2022.

(51) Int. Cl. B01D 46/42; B01D 46/00

(52) U.S. Cl. CPC B01D 46/4227; B01D 46/0005

(57) ABSTRACT

The present disclosure is directed to improved systems and methods for installing one or more filters in one or more desired locations. In embodiments, the system comprises a flexible filter medium, a pair of rails, a pair of ropes each corresponding to a respective one of the pair of rails, and a flexible filter medium, wherein the pair of parallel rails is mounted to a surface, and wherein the ropes are inserted into the rails and connected to the flexible filter medium.

### CROSS REFERENCE TO RELATED APPLICATIONS

This application claims priority to and the benefit of U.S. Provisional Application No. 63/350,069, filed Jun. 8, 2023 and entitled “AIR FILTER MOUNTING SYSTEM,” the content of which is hereby incorporated by reference.

### FIELD OF THE DISCLOSURE

The present disclosure relates to systems and methods for installing and replacing air filters. More particularly, the present disclosure relates to systems and mechanisms for removably installing air filters in hard-to-reach locations without the need for tools or fasteners to removably secure the air filters in place.

### BACKGROUND

Effective air filtration is important in many industrial and commercial settings. Many pollutants, both natural and man-made, exist in the ambient atmosphere, and include industrial pollutants, such sulfur dioxide, volatile organic solvents, particulate matter, and dust, among others, as well as natural pollutants, such as pollen, insects, dust, and smoke, among others. Many of these pollutants are harmful to individuals or can contaminate products or industrial equipment. Additionally, many industrial processes require a high intake of clean air to power machinery and internal ventilation systems. To avoid unwanted contamination, many commercial and industrial practices use a variety of air filtration systems to ensure the air brought into their facilities will not be harmful to their products or to the individuals within those facilities.

Air filtration systems are therefore configured to meet the specific needs of a particular industry or user. Many filtration systems utilize multiple means of filtration to remove different sizes of pollutants. Furthermore, many filtration systems are delicate, expensive, and fine-tuned to remove only a certain subset of the full spectrum of pollutants. To remove some of the largest air pollutants, such as insects, plant seeds, and other large particulates, many filtration systems include a first filter which is exposed to the air outside of the facility, generally positioned to interface directly with the external, outdoor air. External air enters these filters through air intake ports positioned on the exterior of the facility. Although an external air filter may be located on any exterior surface of a building, in general, they are located on vertical exterior walls and are often positioned near the top of the walls as to not interfere with windows or doors on the same wall. Air filters may be located in difficult-to-reach locations or are inaccessible from the ground.

As these filters remain in use, they accumulate contaminates, and can become less effective or reduce the intake of air that can pass through the filter. When filter contamination occurs, the filters must be replaced or cleaned by technicians. When filters are installed in locations that are high off the ground, or in difficult-to-access locations, replacement can be challenging, time-consuming, and dangerous. For example, when a filter intake is positioned near the top of a structure, a technician will require a ladder, chair lift, or other means to be able to reach the filter. Furthermore, filters are generally mounted with nuts and bolts, grommets, rivets, or other affixing hardware. These forms of affixing hardware must be installed or removed by hand, and require a technician to be physically near the filter in order to securely mount it to a desired location, which may be high off of the ground, in a difficult-to-reach location, in a location that is dangerous, or which may take long periods of time to access.

Accordingly, there has long been an unmet need for air filters which can be safely installed or maintained from a position of safety and which do not require technicians to use ladders, chairlifts, or other elevating means to access, install, maintain, or replace air filters.

### SUMMARY OF THE DISCLOSURE

In one aspect of the present disclosure, a system and method for improved air filter installation is disclosed whereby a user may interact with a flexible filter medium without the need to use a ladder, chairlift, or other elevating means to install the flexible filter medium in a higher or difficult-to-reach location.

It is noted that in this disclosure and particularly in the claims and/or paragraphs, terms such as “comprises,” “comprised,” “comprising,” and the like can have the meaning attributed to them in U.S. Patent law; e.g., they can mean “includes,” “included,” “including,” and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the disclosure.

These and other embodiments are disclosed or are obvious from and encompassed by the following Drawings and Detailed Description.

### BRIEF DESCRIPTION OF THE DRAWINGS

The following detailed description, given by way of example, but not intended to limit the disclosure solely to the specific embodiments described, may best be understood in conjunction with the accompanying drawings.

FIG. 1 illustrates a user inserting ropes affixed to a flexible filter medium into a set of parallel rails in order to install the flexible filter medium in a difficult-to-reach location.

FIG. 2 illustrates a flexible filter medium fully installed into a high location without the use of a ladder or other means to raise an individual off of the ground. The embodiment shown in FIG. 2 additionally shows a grommet feature which extends around the flexible filter medium for the portion of the flexible filter medium that is not within the rails.

FIG. 3 depicts an embodiment of the disclosure wherein the flexible filter medium possesses ropes which extend from the top portion of the flexible filter medium along the edge of the flexible filter medium such that when the ropes are attached the flexible filter medium is inserted into the rails, the ropes are fully enclosed by the rails. FIG. 3 further shows a grommet section extending around the bottom portion of the flexible filter medium to facilitate manipulation of that portion of the flexible filter medium that is connected to the ropes. This grommet section further assists a user to remove the flexible filter medium. FIG. 3a depicts a narrow embodiment of the flexible filter medium. FIG. 3b depicts a narrow embodiment of the rails. FIG. 3c depicts another view of a narrow flexible filter medium embodiment.

FIG. 4 depicts an embodiment of a cross section of a rope which can be inserted into a rail to slidably move a flexible filter medium wherein the rope has a y-shaped flange.

FIG. 5 depicts a front quarter view of an embodiment of a portion of a rope which can be modified to be inserted into a rail to slidably move a flexible filter medium wherein the rope is attached to a y-shaped flange. The flanges of the rope section may be removed and the rope may be connected to the flexible filter medium.

FIG. 6 depicts an embodiment of a rail which can be mounted to a wall or other surface and which can accommodate a rope which is affixed to a flexible filter medium to be slidably inserted into the rails.

FIG. 7 depicts a front view of an embodiment of a rail which can be mounted to a wall or other surface and which can accommodate a rope which is affixed to a flexible filter medium to be slidably inserted into the rails.

FIG. 8 depicts an embodiment of the disclosure wherein the rope is attached to the flexible filter medium, and an adhering strip is affixed to the top portion of the flexible filter medium.

FIG. 9 depicts an embodiment of the disclosure wherein the rope attached to the flexible filter medium is prepared to be inserted into the vertically mounted rail.

FIG. 10 depicts an embodiment of the disclosure wherein the rope is attached to the flexible filter medium as it is inserted into the vertically mounted rail.

FIG. 11 depicts an alternative embodiment of the present disclosure for a wide flexible filter medium. FIG. 11a depicts a wide embodiment of the flexible filter medium. FIG. 11b depicts wide rail embodiments as well as a magnet securing strip. FIG. 11c depicts another view of a wide embodiment of the flexible filter medium.

FIG. 12 depicts an alternative embodiment of the rails wherein the rails have a plurality of channels to accommodate multiple ropes.

FIG. 13 depicts an alternative embodiment of the rails wherein the rails have a plurality of channels, and where in each channel a rope may be accommodated.

FIG. 14 depicts a rail accommodating a rope.

FIG. 15 depicts an alternative embodiment wherein a plurality of flexible filter mediums are affixed to a plurality of ropes wherein the ropes have been installed in a plurality of channels.

FIG. 16 depicts an alternative embodiment wherein the disclosure comprises a plurality of rails which can accommodate a plurality of filters.

FIG. 17 depicts a rail capable of receiving a rope.

FIG. 18 depicts a rope and a flange capable of being inserted into a rail and which can be affixed to a flexible filter medium.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. The following detailed description is, therefore, not to be taken in a limiting sense.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail to avoid unnecessarily complicating the instant disclosure.

As used herein, the terms “comprises,” “comprising,” “includes,” “including,” “has,” “having,” or any other variation thereof, are intended to cover a nonexclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more items or terms, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of “a” or “an” is employed to describe elements and components of the embodiments herein. This is done merely for convenience and to give a general sense of the inventive concepts. This description should be read to include one or at least one, and the singular also includes the plural unless it is obvious that it is meant otherwise.

The use of the terms “at least one” and “one or more” will be understood to include one as well as any quantity more than one, including, but not limited to, each of 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

The present disclosure provides systems and methods for securing a filter 115 in a desired location. Particular embodiments provide a system and method for installing a flexible filter medium 115 (also herein referred to as a filter) in a relatively inaccessible, difficult-to-reach, or dangerous location.

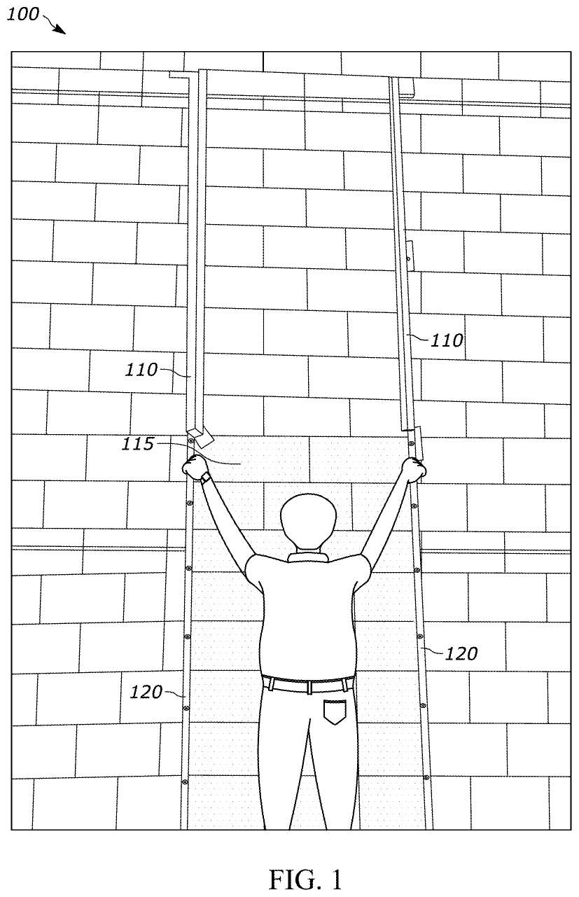

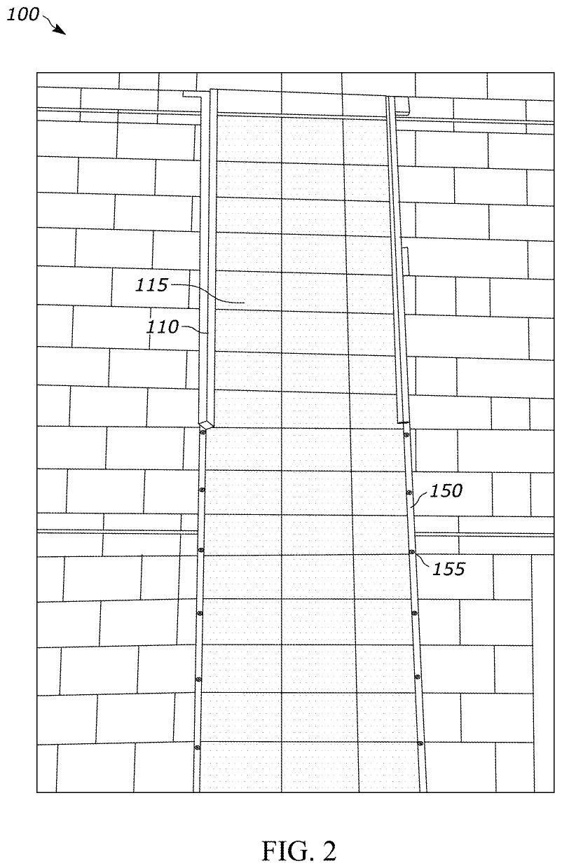

As shown in FIGS. 1 and 2, in an embodiment the system 100 comprises a set of rails 110 that are mounted to a surface in a parallel or substantially parallel manner to one another and are capable of receiving a set of ropes 120 which are affixed to opposite edges of a flexible filter medium 115. Each rail 110 comprises a channel or passageway 114 sized to receive a respective rope 120. A user can insert the ropes 120 into the corresponding portion of the rails 110. When inserted into the rails 110, the ropes 120 are frictionally held in place such that if a user stops exerting a force (whether upwards or downwards), the ropes 120 are held in place and will not, for example, slide down the rails 110 out of a desired position. Once a user again exerts a force (whether upwards or downwards) on the filter 115, the ropes 120 may again be slid in a desired direction relative to the rails 110. In this manner, a filter 115 may be inserted into a lower end of the rails 110 and raised into place by exerting an upward force proximate to the bottom end of the rails 110. Thereafter, the filter 115 may be removed (such as for cleaning, maintenance, or replacement) by exerting a downward force to lower the filter 115 and ultimately decouple the ropes 120 from the rails 110. As shown in FIG. 1, such method avoids the need for a ladder, lift, or other device to enable a user to gain direct access to the top of the flexible filter medium 115 once it is installed. This improves user safety and substantially decreases the time required to install or remove a filter 115.

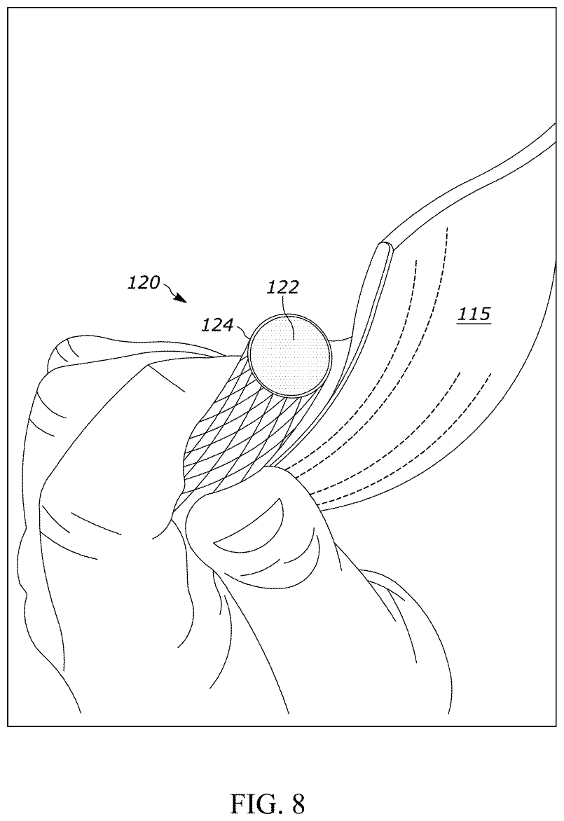

FIGS. 8, 9, and 10 depict an embodiment of a method for installing a flexible filter medium 115 into rails 110. In the embodiment shown in FIG. 8, a rope 120 comprises a central cylinder portion 122 which is covered by a flexible material 124 which encases the cylinder portion 122 on all sides. The flexible material 124 is operatively connected to the flexible filter medium 115. In the embodiment shown, the flexible material 124 is joined to the flexible filter medium 115 by a connector flange 126 extending away from the cylinder 122. In other embodiments, the flexible material 124 may be joined to the flexible filter medium 115 by another mechanism. In an embodiment, the flexible material 124 surrounds the flexible filter medium 115, such that the flexible filter medium 115 is held securely between layers of flexible material 124.

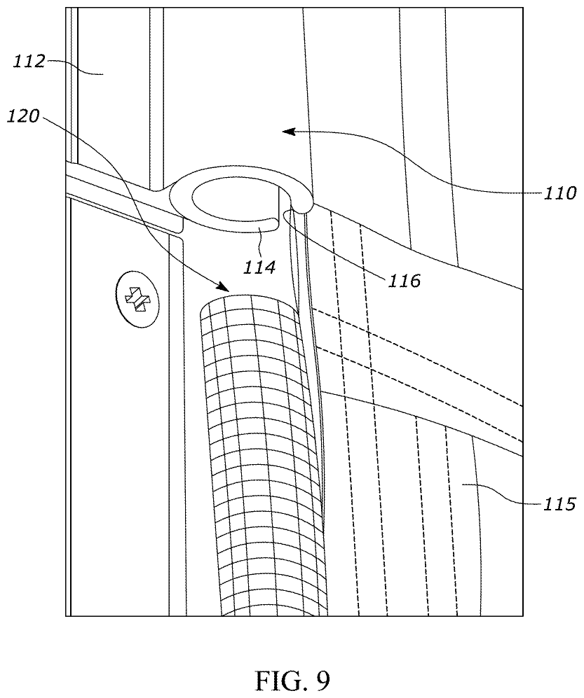

As shown in FIG. 9, to install the flexible filter medium 115 in the rails 110, a rope 120 is aligned with a respective passageway 114 in a corresponding rail 110. The rope 120 is oriented such that the flange 126 is aligned with the gap 116 in the rail 110. In alternative embodiments, the filter 115 or connection to the filter 115 may instead be aligned with the gap 116. As will be clear to one of skill in the art, the same process is used on each respective rope and corresponding rail such that both ropes 110 are inserted into their corresponding passageways 114.

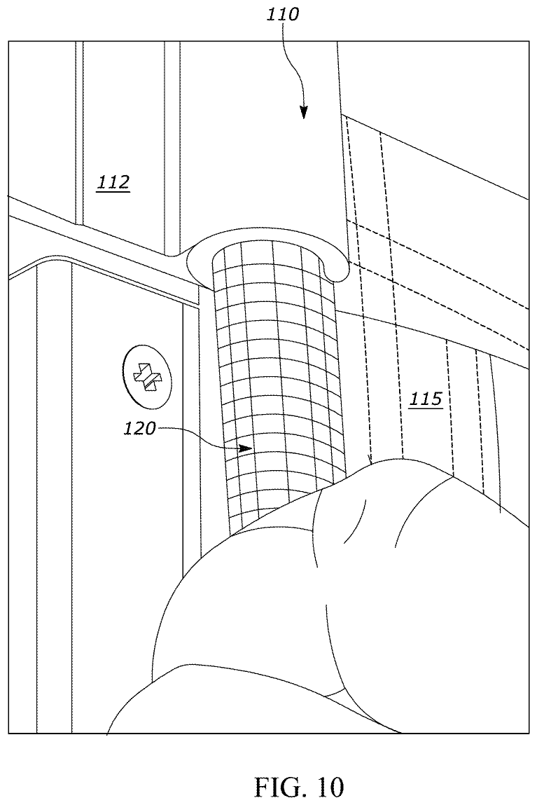

As shown in FIG. 10, the ropes 110 are then threaded through the passageways 114 in the rails 110 until the filter 115 reaches a desired location.

Rails

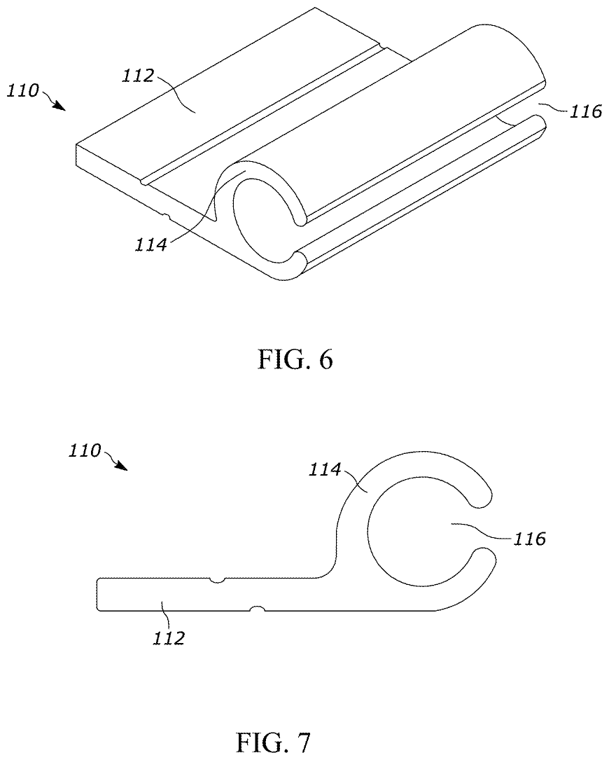

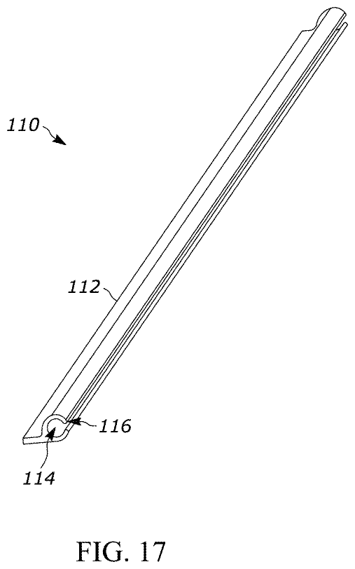

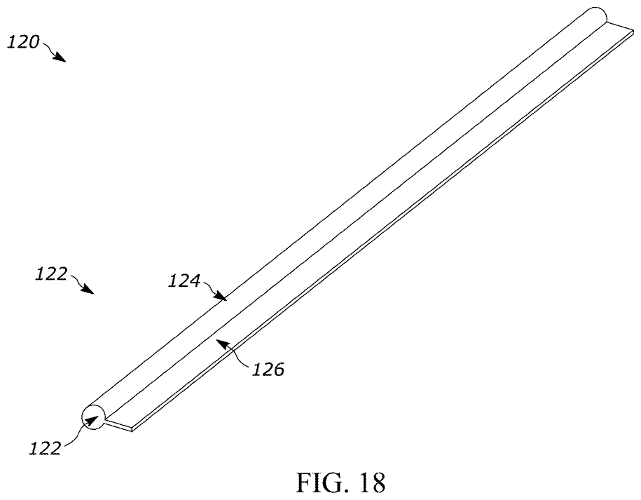

In the embodiments shown in FIGS. 6, 7, 12, 13, 14, 15, 17, and 18 rails 110 comprise a mounting portion 112 that may be secured to a surface, such as a wall. The rails 110 may be secured to a surface (vertical or otherwise) while using any known attachment mechanism, such as fasteners, adhesives, welding, or other known mechanisms for joining to materials. The rails 110 further comprise a semi-enclosed tube or channel 114 having a gap 116 therein, with the tube 114 sized to accommodate the cylindrical body of a respective rope 120, and wherein the gap 116 may accommodate a flange 126 of the rope 120. In other embodiments, the gap may be sized to accommodate the filter 115 (i.e., where the filter 115 is directly connected to the rope 120) or other attachment mechanism between the rope 120 and the filter 115. The flange 126 extends laterally through the gap 116 along the length of the semi-enclosed tube 114. As shown by FIGS. 1, 2, 9 and 10, the rails 110 may be secured on a surface (including, but not limited to, a vertical or near vertical surface, such as a wall) to be accessed by a user positioned below the bottom of the rails 110. The rails 110 may be secured to any surface. In an embodiment, the rails 110 are configured to extend away from a point proximate to an access point in any direction (i.e., downwardly, upwardly, laterally, or at an angle) so as to enable a filter 115 to be installed by a user located at the access point, such as to enable the filter 115 to be ultimately positioned away from the access point (e.g., higher than a user as shown in FIGS. 1 and 2). In an embodiment, a user may use a rope attached to a pulley to raise a filter 115 into a desired location that is substantially higher than a user. In an alternative embodiment, a user may utilize a rigid object (such as a pole) to lift a filter 115 to a position higher than a user can reach.

In the embodiments shown, the rails 110 are rigid such that when a set of ropes 120 is inserted into the rails 110, the ropes 120 are held in place by friction alone. In an alternative embodiment, the rails 110 may be flexible and sufficient rigidity is imparted thereon by the surface to which the rails 110 are connected. It is also contemplated that the rails 110 may be positioned in such a way that the rails 110 extend in a direction away from a user. In an embodiment, the rails 110 extend below a user, and in such case, the ropes 120 affixed to the flexible filter medium 115 would be able to be inserted into the rails 110 because both the ropes 120 and the flexible filter medium 115 are flexible and can be inserted into the rails 110 either in a linear fashion or the ropes 120 affixed to the flexible filter medium 115 can be inserted into the rails 110 by bending the ropes 120 and the flexible filter medium 115.

Additional embodiments of the rails 110 are contemplated. In an embodiment, the rails 110 extend horizontally across a surface, for example when an air intake port is accessible only from a horizontal direction. As will be clear to one of skill in the art, in other embodiments, the rails 110 are placed on a surface of any orientation, including without limitation, a vertical wall or a horizontal surface, such as a rooftop or ceiling. In embodiments, the rails are attached to a surface which is not flat. In embodiments, the rails are only connected at disparate locations (e.g., a top and bottom) of a surface. In other embodiments, the rails are not straight but instead bend or turn to more closely match the shape of the surface. In embodiments, entirety of the ropes 120 and flexible filter medium 115 are substantially flexible, permitting the ropes 120 and flexible filter medium 115 to be slid along the rigid track formed by the rails 110 and into a desired position. The ropes 120 may be secured with friction from the rails 110 alone or alternatively by magnets or other affixing hardware positioned along the topmost portion of the filter 115 such that the magnets or affixing hardware is secured in place once the filter 115 is in a desired position.

Ropes

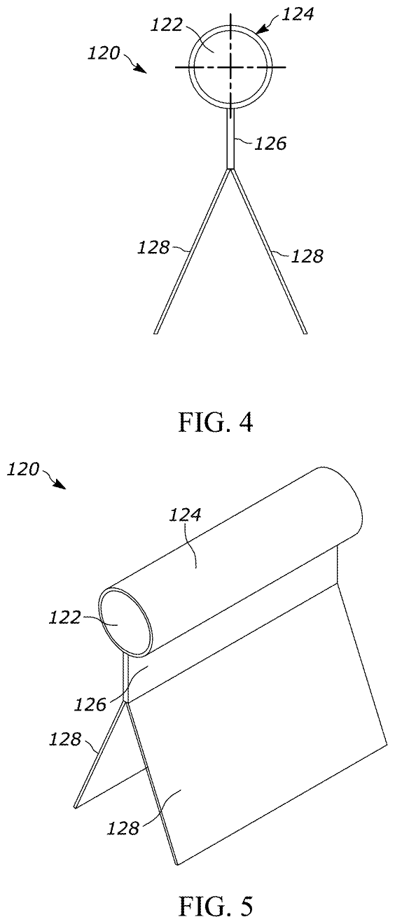

As shown in FIGS. 4, 5, 9, 10, and 18, in embodiments the ropes 120 comprise a central cylinder portion 122 which is covered by a flexible material 124 which encases the cylinder 122 on all sides and which forms a connector flange 126 extending away from the cylinder 122.

FIGS. 4 and 5 depict an embodiment of a rope 120 with a connector flange 126 which extends from the cylinder 122 and then divides into two additional flanges 128. The flanges 128 may be connected to the flexible filter medium 115 by any known means, including heatsealed, sewn, glued, or any other connecting means understood by one of ordinary skill in the art. Other embodiments of the ropes 120 are contemplated. For example, in an embodiment, additional flanges 128 are omitted such that there is only a connector flange 126 that extends from the cylinder 122 which can connect to the filter 115.

Various sizes of ropes 120 are contemplated, including, but not limited to, those listed in Table 1, shown below.

TABLE 1

| | Rope Dimensions (mm) | | |
|---|---|---|---|
| Rope Size | A | B | C |
| 7.5 mm ( 9/32 in.) | 7.5 | 10 | 30 |
| 8.5 mm ( 5/16 in.) | 8.5 | 10 | 30 |
| 8.5 mm ( 5/16 in.) | 8.5 | 10 | 30 |
| 10 mm ( 13/32 in.) | 10 | 10 | 30 |
| 10 mm ( 13/32 in.) | 10 | 10 | 30 |
| 11 mm ( 7/16 in.) | 11 | 10 | 30 |
| 11 mm ( 7/16 in.) | 11 | 10 | 30 |
| 12 mm ( 15/32 in.) | 12 | 10 | 30 |
| 13 mm ( 15/32 in.) | 13 | 10 | 30 |
| 13 mm ( 15/32 in.) | 13 | 10 | 30 |

Column A of Table 1 indicates the diameter of the cord and fabric of the rope 120, Column B of Table 1 depicts the weld width, and Column C of Table 1 depicts the width of the connector flange 126 (or flap). As will be clear to one of skill in the art, the size of the rope 120 (and corresponding size of the rail 110) may be selected based on the weight of the filter 115 and other design parameters required for a particular application or location.

As depicted in FIGS. 9, 10, and 11, in embodiments, the ropes 120 comprise flexible or semirigid cylindrical tubes 122 covered with a protective weave 124 affixed to the edges of a flexible filter medium 115. The weave may be formed from a weldable (i.e., heat or ultrasonic weldable) material enabling the rope 120 to be readily attached to a flexible filter medium 115. In some embodiments, the ropes 120 may be sufficiently flexible such that they can bend or curve to enter the rails 110, but may also be configured to maintain some rigidity so that when a user exerts a force on the ropes 120 through the rails 110, the structure of the ropes 120 will be guided along the path of the rails 110. The shape of the ropes 120 and protective weave 124 are configured to fit tightly within the rails 110. This further allows the ropes 120 to be inserted into a variety of rail 110 configurations, including, but not limited to, substantially linear rails 110 or rails which bend and/or twist into a nonlinear configuration in order to be mounted to a particular surface.

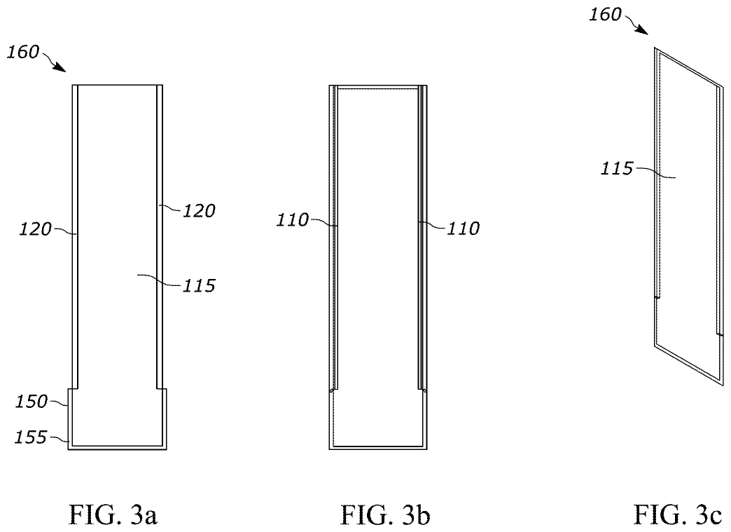

In an embodiment, depicted in FIGS. 3a, 3b, and 3c, the flexible filter medium 115 is sewn to the ropes 120. In alternative embodiments, the flexible filter medium 115 is welded (e.g., heatwelded or ultrasonic welded) to the ropes 120. Other forms of affixing or connecting the flexible filter medium 115 to the rope 120 may be used, as would be understood by one of ordinary skill in the art.

Additional Features

FIGS. 3a, 3b, and 3c depict an embodiment wherein the flexible filter medium 115 additionally contains a portion of the flexible filter medium 115 which extends below the rails 110 when the flexible filter medium 115 is in place. FIGS. 3a, 3b, and 3c show a portion of the flexible filter medium 115 not fully inserted into the rail 110 in order to more easily allow a user to manipulate the placement of the filter 115 over the air intake port. This portion of the flexible filter medium 115 may contain a lip 150 and grommets 155, which may assist with the installation of the flexible filter medium 115. The grommets 155 may be attached to a positive mount, such as a fastener, a traditional grommet mount, or other means of securing a grommet 155 as would be understood by one of ordinary skill in the art.

In the embodiment shown in FIG. 3a, the grommets 155 at the bottom end of the flexible filter medium 115 secure the flexible filter medium 155 in place. In order to remove the flexible filter medium 115, it is first necessary to remove or disengage the grommets 115. In embodiments in which the friction generated by the ropes 120 in contact with the rails 110 is insufficient to hold the flexible filter medium 115 in place alone, an upward or supporting force may be applied to the flexible filter medium 115 prior to disengaging the grommets so as to ensure the flexible filter medium 115 remains in place until a user is ready to remove the flexible filter medium 115.

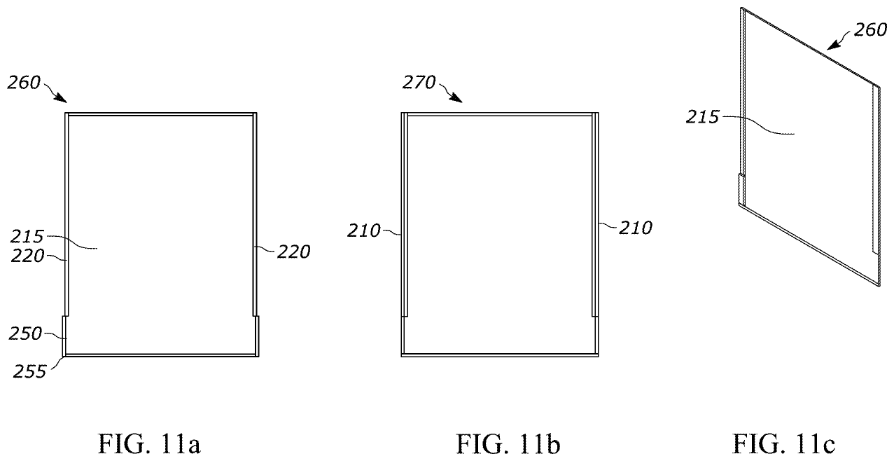

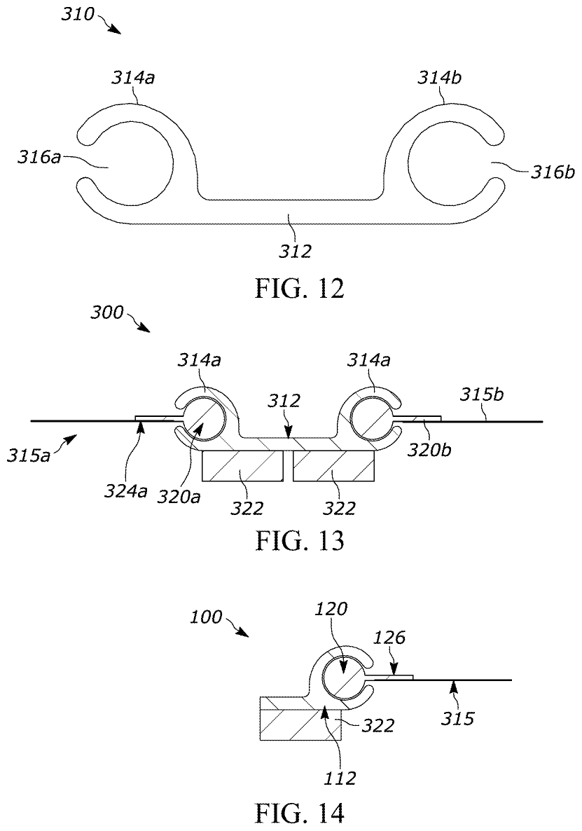

Another embodiment of the flexible filter medium 215 is depicted in FIGS. 11a, 11b, and 11c. FIG. 11a depicts a wide flexible filter medium 215. The wide flexible filter medium 215 has two ropes 220 which extend along either side of the flexible filter medium 215. The wide embodiment of the flexible filter medium additionally contains a lip 250 with grommets 255 to facilitate insertion into the rails 210. The flexible filter medium 215 may optionally contain an adhering strip 260. The adhering strip 260 corresponds to a securing strip 270. FIG. 11b. depicts the securing strip 270 to use magnets; however, as would be understood by one of ordinary skill in the art, other securing means may be used (including, but not limited to, adhesives, mechanical fasteners, etc.). FIG. 11b depicts a wide embodiment of the rails 210 and a securing strip 270. FIG. 11c depicts an additional view of the flexible filter medium 215 depicted in FIG. 12a.

In an embodiment, depicted in FIGS. 3a, 3b, and 3c, the flexible filter medium 115 contains an additional adhering strip 160 proximate the top portion of the flexible filter medium 115. In an embodiment, the adhering strip 160 adds rigidity to the top portion of the flexible filter medium 115 so as to keep the flexible filter medium 115 in a desired location. In an embodiment, the adhering strip 160 contains rare earth magnets and a corresponding magnetic securing strip is located between the rails 110. As the flexible filter medium 115 is slid into its installed position, the magnets engage with the magnetic securing strip to hold the top portion of the flexible filter medium 115 in the installed position. The magnets may be disengaged by exerting sufficient force on the flexible filter medium 115, thereby pulling the magnets away from the securing strip. As will be clear to one of ordinary skill in the art, in alternative embodiments the adhering strip 160 may be any affixing hardware to secure the flexible filter medium 115 when installed. By way of example, in embodiments, adhesives or mechanical fasteners may be used to affix the adhering strip in place.

FIGS. 12, 13, 15, and 16 depict an alternative embodiment of the present disclosure 300. In FIGS. 12, 13, 15, and 16, a plurality of filters 315 are installed into rails 310. The rails 310 are configured to accommodate a plurality of ropes 320.

As shown in FIGS. 12 and 13, in an embodiment, a first rope 320a is inserted into a first channel 314a in a mounting portion 312 such that a first flange 324a extends through a first gap 316b in the first channel 314a. Similarly, a second rope 320b is inserted into a second channel 314b in the mounting portion 312 such that a second flange 324b extends through a second gap 316b in the first channel 314b. The mounting portion 312 is then secured to a surface 322. As shown, the mounting portion 312 may be secured to the surface as multiple points. In the embodiment shown, the first and second channels 314a, 314b are located proximate one another. In alternative embodiments, the first and second channels 314a, 314b may be separated from one another and the mounting portion 312 may be elongated so as to space the channels 314a, 314b apart.

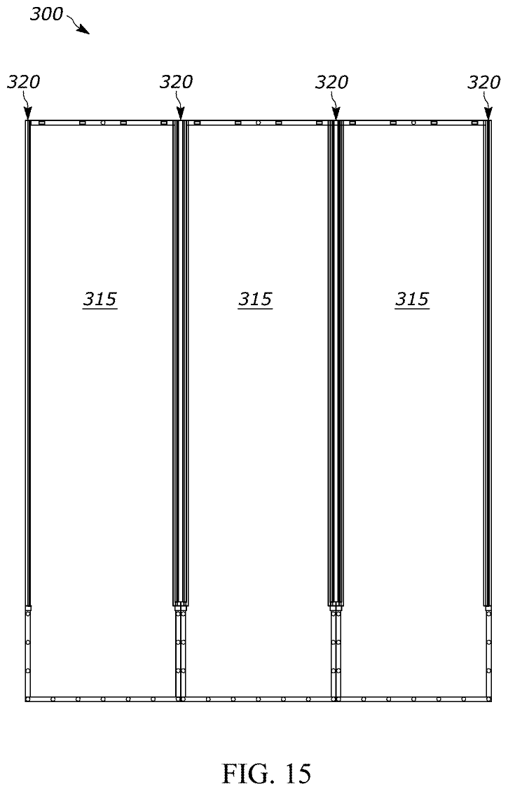

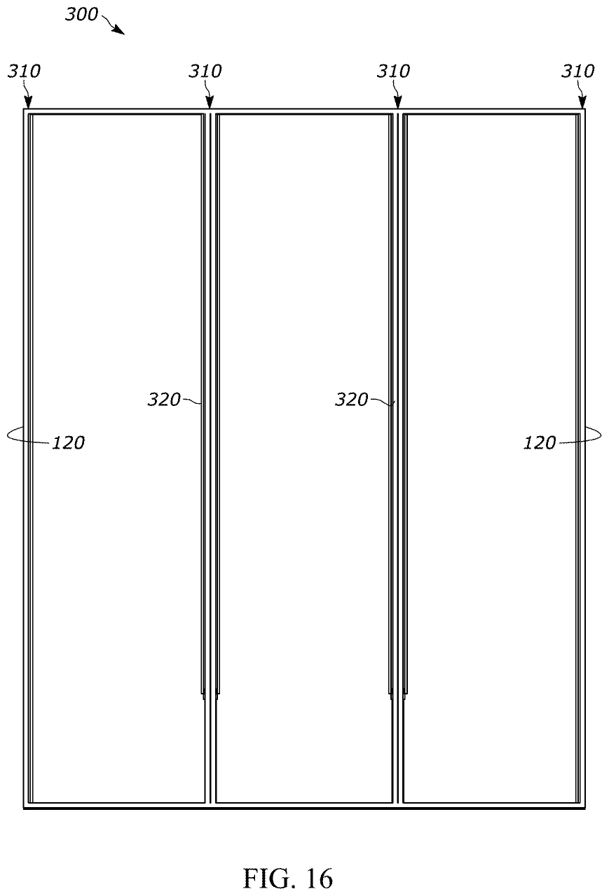

Using double-sided mounting portions 312, multiple filters 315 may be arranged side by side, with the spacing between filters determined by the width of the mounting portions 312. In the embodiment shown in FIG. 15 (depicting the filters 315 and ropes 320) and FIG. 16 (depicting the rails and mounting portions), two double-sided mounting portions 320 are used with two single-sided mounting portions 120 to align three filters 315 side-by-side. As will be clear to one of skill in the art, additional filters may also be placed in a side-by-side arrangement through the use of additional rails and mounting portions.

As will be clear to one of ordinary skill in the art, although the present disclosure and its advantages have been described in detail, it should be understood that various changes, substitutions, and alterations can be made herein without departing from the spirit and scope of the disclosure as defined in the appended claims.

Having thus described in detail preferred embodiments of the present disclosure, it is to be understood that the disclosure defined by the above paragraphs is not to be limited to particular details set forth in the above description as many apparent variations thereof are possible without departing from the spirit or scope of the present disclosure.

1. A system for mounting a filter, the system comprising:
a first rail comprising a first channel;
a second rail comprising a second channel;
a first rope configured to be inserted into the first channel of the first rail;
a second rope configured to be inserted into the second channel of the second rail; and
a first filter having a first side and a second side, wherein the first rope is connected to the first side and the second rope is connected to the second side.

2. The system of claim 1, wherein the first rope comprises a first flexible material and the first flexible material is connected to the first side of the first filter.

3. The system of claim 2, wherein a first flange extends from the first side and the first flexible material is connected to the first flange.

4. The system of claim 3, wherein the first rope comprises a first semirigid core and the first flexible material surrounds the first semirigid core.

5. The system of claim 2, wherein the second rope comprises a second flexible material and the second flexible material is connected to the second side of the first filter.

6. The system of claim 5, wherein a second flange extends from the second side and the second flexible material is connected to the second flange.

7. The system of claim 6, wherein the second rope comprises a second semirigid core and the second flexible material surrounds the second semirigid core.

8. The system of claim 1, wherein the first rope has a diameter of between 7 and 13.5 millimeters.

9. The system of claim 1, wherein the first rope is substantially cylindrical.

10. The system of claim 1, wherein the first rail is affixed to a surface.

11. The system of claim 10, wherein the surface is vertical and the first rail is rigidly mounted to the surface.

12. The system of claim 1, wherein the first filter further comprises a flexible lip which extends from the first filter below the first rail.

13. The flexible lip of claim 12, wherein the flexible lip further comprises affixing hardware for removably securing the first filter in a desired location.

14. The flexible lip of claim 13, wherein the affixing hardware comprises one or more magnets.

15. The system of claim 1, wherein the second rail further comprises a third channel, the system further comprising:
a third rail comprising a fourth channel;
a third rope configured to be inserted into the third channel of the second rail;
a fourth rope configured to be inserted into the fourth channel of the third rail; and
a second filter having a third side and a fourth side, wherein the third rope is connected to the third side and the fourth rope is connected to the fourth side.

16. The system of claim 15, wherein the first filter is secured between the first rail and the second rail and the second filter is secured between the second rail and the third rail.

17. A method of installing a filter attached to a first rope and a second rope in a desired location, the method comprising:
aligning the first rope with a first channel in a first rail;
aligning the second rope with a second channel in a second rail;
threading the first rope into the first channel;
threading the second rope into the second channel;
moving the first rope through the first channel and the second rope through the second channel until the filter reaches the desired location.

18. The method of claim 17, wherein aligning the first rope with the first channel further comprises aligning a first flange extending from the first rope with a first gap in the first channel, wherein the filter is connected to the first rope via the first flange.

19. The method of claim 18, wherein aligning the second rope with the second channel further comprises aligning a second flange extending from the second rope with a second gap in the first channel, wherein the filter is connected to the second rope via the second flange.

20. The method of claim 17, wherein the desired location is a first desired location and the filter is a first filter, the method further comprising moving a second filter attached to a third rope and a fourth rope to a second desired location by:
aligning the third rope with a third channel in the second rail;
aligning the fourth rope with a fourth channel in a third rail;
threading the third rope into the third channel;
threading the fourth rope into the fourth channel;
moving the third rope through the third channel and the fourth rope through the fourth channel until the second filter reaches the desired location.
